(19) United States
(12) Patent Application Publication
(10) Pub. No.: US 2026/0245173 A1
(43) Pub. Date: Aug. 20, 2026

(54) DISPLAY PROCESSING

(71) Applicant: Beijing Zitiao Network Technology Co., Ltd., Beijing (CN)

(72) Inventor: Xiaosong WANG, Beijing (CN)

(21) Appl. No.: 19/455,284

(22) Filed: Jan. 21, 2026

(30) Foreign Application Priority Data
Feb. 18, 2025 (CN) 202510180104.3

(51) Int. Cl. G06T 3/4053; G06T 5/70; G06T 5/73

(52) U.S. Cl. CPC G06T 3/4053; G06T 5/70; G06T 5/73

(57) ABSTRACT

According to embodiments of the disclosure, a method, an apparatus, a device, a medium, and a product for display processing are provided. The method includes: receiving a composition layer to be presented on a display screen and auxiliary information of at least one first layer merged into the composition layer, the auxiliary information at least indicating a size of each first layer and a position of each first layer in the composition layer; performing, based on the auxiliary information of the at least one first layer, an image processing operation on at least one area in the composition layer to obtain a processed composition layer; and performing, based on the processed composition layer, presentation on the display screen.

### CROSS-REFERENCE

This application claims the benefit of CN Patent Application No. 202510180104.3, filed on February 18, 2025, and entitled "METHOD, APPARATUS, DEVICE, MEDIUM AND PRODUCT FOR DISPLAY PROCESSING", which is hereby incorporated by reference in its entirety.

### FIELD

Example embodiments of the present disclosure generally relate to the field of computers, and in particular, to display processing.

### BACKGROUND

With the popularization of intelligent terminal devices and the rapid development of mobile internet, modern computing terminals are gradually developing towards more immersive and higher-quality visual experience. In particular, in terminal devices such as extended reality (XR) devices, smart phones, tablet computers, etc., users have put forward higher requirements for more realistic and clearer image quality and lower latency performance.

### SUMMARY

In a first aspect of the present disclosure, a method for display processing is provided. The method includes: receiving a composition layer to be presented on a display screen and auxiliary information of at least one first layer merged into the composition layer, the auxiliary information at least indicating a size of each first layer and a position of each first layer in the composition layer; performing, based on the auxiliary information of the at least one first layer, an image processing operation on at least one area in the composition layer to obtain a processed composition layer; and performing, based on the processed composition layer, presentation on the display screen.

In a second aspect of the present disclosure, an apparatus for display processing is provided. The apparatus includes: a receiving module configured to receive a composition layer to be presented on a display screen and auxiliary information of at least one first layer merged into the composition layer, the auxiliary information at least indicating a size of each first layer and a position of each first layer in the composition layer; an image processing module configured to perform, based on the auxiliary information of the at least one first layer, an image processing operation on at least one area in the composition layer to obtain a processed composition layer; and a presenting module configured to perform, based on the processed composition layer, presentation on the display screen.

In a third aspect of the present disclosure, an electronic device is provided. The device includes at least one processor; and at least one memory coupled to the at least one processor and storing instructions for execution by the at least one processor. The instructions, when executed by the at least one processor, causing the electronic device to perform the method of the first aspect.

In a fourth aspect of the present disclosure, a computer-readable storage medium is provided. The computer-readable storage medium has computer-executable instructions stored thereon, the computer-executable instructions being executable by a processor to implement the method of the first aspect.

In a fifth aspect of the present disclosure, a computer-executable instruction product is provided. The computer-executable instruction product is tangibly stored in a computer storage medium and includes computer-executable instructions that, when executed by a device, cause the device to perform the method of the first aspect.

It should be understood that the summary described in this disclosure is not intended to limit key features or important features of embodiments in the present disclosure, nor is it intended to limit the scope in the present disclosure. Other features in the present disclosure will become readily understood from the following description.

### BRIEF DESCRIPTION OF THE DRAWINGS

The above and other features, advantages and aspects of the embodiments of the present disclosure will become more apparent in combination with the drawings and with reference to the following detailed description. In the drawings, the same or similar reference symbols refer to the same or similar elements, where:

FIG. 1A illustrates a schematic diagram of an example environment in which the embodiments of the present disclosure can be implemented;

FIG. 1B illustrates a schematic diagram of an example process of display processing;

FIG. 1C illustrates a schematic diagram of another example process of display processing;

FIG. 2 illustrates a flowchart of a process for display processing according to some embodiments of the present disclosure;

FIG. 3 illustrates a schematic diagram of an example process of display processing according to some embodiments of the present disclosure;

FIG. 4 illustrates a schematic structural block diagram of an apparatus for display processing according to some embodiments of the present disclosure; and

FIG. 5 illustrates a block diagram of an electronic device in which one or more embodiments of the present disclosure can be implemented.

### DETAILED DESCRIPTION OF EMBODIMENTS

The embodiments in the present disclosure will be described in more detail below with reference to the accompanying drawings. Although certain embodiments in the present disclosure are shown in the drawings, it would be appreciated that the present disclosure can be implemented in various forms and should not be interpreted as limited to the embodiments described in this specification. On the contrary, these embodiments are provided for a more thorough and complete understanding in the present disclosure. It would be appreciated that the accompanying drawings and embodiments in the present disclosure are only for the purpose of illustration and are not intended to limit the scope of protection in the present disclosure.

In the description of the embodiments of the present disclosure, the term “including” and similar terms would be appreciated as open-ended inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below.

Herein, unless expressly stated herein, performing a step "in response to A" does not mean that the step is performed immediately after "A", but may include one or more intermediate steps.

It would be appreciated that the data involved in this technical solution (including but not limited to the data itself, data acquisition or use) shall comply with the requirements of corresponding laws, regulations and relevant provisions.

It would be appreciated that before the technical solution disclosed in the embodiments in the present disclosure is used, users should be informed of the type, the scope of use, the use scenario, etc. of the personal information involved in the present disclosure in an appropriate manner and in accordance with relevant laws and regulations, and the authorization of the users may be obtained.

For example, in response to an active request being received from a user, a prompt message is sent to the user to explicitly prompt the user that the operation requested by the user would need acquisition and use of personal information of the user. As such, according to prompt information, users may choose whether to provide personal information to the software or hardware, such as an electronic device, application, server or storage medium, that performs the operations of the technical solution in the present disclosure.

As an optional but non-limiting implementation, in response to the active request being received from the user, the prompt information may be sent to the user via, for example, a pop-up window in which the prompt information may be presented in text. In addition, the pop-up window may also contain selection controls configured for the user to choose “agree” or “disagree” to provide the personal information to the electronic device.

It would be appreciated that the above process of notification and acquisition of user authorization is only illustrative and does not limit the implementations in the present disclosure. Other methods that meet relevant laws and regulations may also be applied to the implementations in the present disclosure.

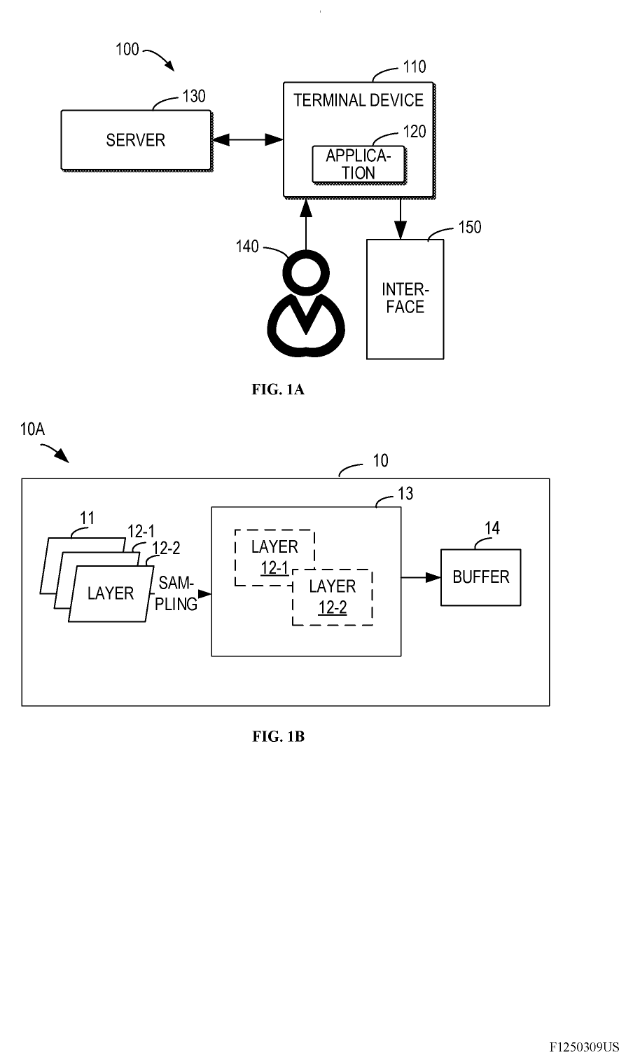

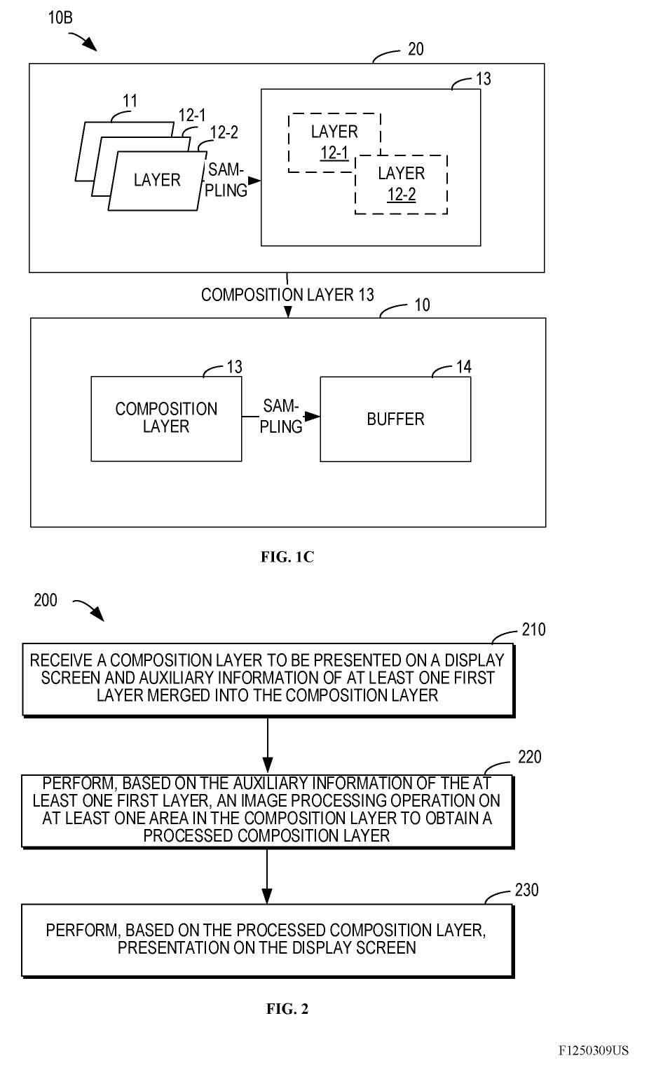

FIG. 1A illustrates a schematic diagram of an example environment 100 in which the embodiments of the present disclosure can be implemented. In this example environment 100, an application 120 is installed on a terminal device 110. A user 140 may interact with the application 120 via the terminal device 110 and/or an attachment device of the terminal device 110. The application 120 may be any appropriate application. In some embodiments, the terminal device 110 may be an extended reality (XR) device, including a virtual reality (VR) device, an augmented reality (AR) device, and a mixed reality (MR) device.

In the environment 100 of FIG. 1A, if the application 120 is active, the terminal device 110 may present an interface 150 of the application 120. The interface 150 may include various types of user interfaces that may be provided by the application 120. The application 120 may provide a content viewing function to view various types of content published in the application 120. Via corresponding pages, the application 120 may provide various types of online content to the user 140. The embodiments of the present disclosure are not intended to limit the specific functions of the application and the presented content. The application may be activated to run via an appropriate trigger, such as clicking or selecting an application icon. Note that although a single application is shown in the figure, a plurality of applications may actually be installed and run on the terminal device 110.

In some embodiments, the terminal device 110 communicates with the server 130 to implement the provision of the services of the application 120. The terminal device 110 may be any type of mobile terminal, fixed terminal or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a game device, or any combination of the foregoing, including the accessories and peripherals of these devices or any combination thereof. In some embodiments, the terminal device 110 may also support any type of user-oriented interface (such as a "wearable" circuit, etc.). The server 130 may be various types of computing systems/servers capable of providing computing capability, including but not limited to mainframes, edge computing nodes, computing devices in cloud environments, and so on.

It should be understood that the structure and function of each element in the environment 100 are described only for the purpose of illustration, and do not imply any limitation on the scope of the present disclosure.

As briefly mentioned above, with the advancement of computer graphics processing and display technologies, users’ demands for high-quality display and smooth visual experience have been continuously increasing. To enhance the visual experience, devices need to strike a balance among high-resolution display, low-latency rendering, and optimization of computing resources. Especially in XR devices, including VR, AR, MR and other devices, the display system not only needs to ensure high-quality image synthesis, but also needs to adapt to different hardware architectures, bandwidth limitations and computing capabilities to ensure a smooth user experience.

In terminal graphics rendering and display technologies, the final image presented on the display screen is usually obtained by compositing the plurality of layers. FIG. 1B illustrates a schematic diagram of an example process 10A of display processing. As shown in FIG. 1B, the process of layer composition may be performed at a processing unit 10. The processing unit 10 may be understood as a runtime environment of the device, which serves as a core software layer of the terminal device and is responsible for coordinating hardware resources and managing the lifecycle of applications.

The layer 11 may be image data stored in a buffer (for example, an eyebuffer), and for example, the layer 11 may be a background layer. The layer 12 may be a layer overlaid on the layer 11, for example, a foreground layer, a user interface (UI) control layer, and the like.

The processing unit 10 may perform sampling and composition processing on the layers to obtain a final composition layer 13 (that is, a complete frame of image). Then, the processing unit 10 may send the composition layer 13 to a buffer 14 to present the final composition layer 13 on the display screen.

At present, a new processing component or module has also been proposed to take over all layers (including the layer 11 and the layer 12) to perform unified rendering and composition. In this way, different application interfaces can achieve certain complex global effects (such as light effects, shadows, etc.), thereby further improving the display effect. The composition result generated by the processing component or module will be delivered to a downstream processing module, and the downstream processing module will perform subsequent processing before being displayed on the screen.

FIG. 1C illustrates a schematic diagram of another example process 10B of display processing. As shown in FIG. 1C, a processing unit 20 may be introduced, and the composition operation of all layers may be performed by the processing unit 20. Finally, the processing unit 20 may output a complete composition layer 13 and deliver it to the processing unit 10 for processing. The processing unit 20 is equivalent to a "preprocessor" or a "composition engine", and its function is to combine the plurality of layers to obtain a final image (composition layer).

The processing unit 10 may receive the composition layer 13 sent by the processing unit 20, and perform a sampling operation to adapt to the resolution of the display screen of the device. The composition layer 13 after the sampling processing may be delivered to the buffer 14 having the same resolution as the display screen. Then, the composition layer 13 is finally presented on the display screen by a HAL (Hardware Abstraction Layer) module configured to perform window composition and display.

The manner of performing layer composition at the processing unit 20 still introduces some new issues. In the process 10B, the processing unit 20 transmits the composition layer 13 to the processing unit 10 after composing and sampling the plurality of layers. In the processing unit 10, a sampling process also needs to be performed to enable the composition layer 13 to match the resolution of the display screen. Therefore, compared with the process 10A, the display processing manner in the process 10B introduces an additional sampling process, which may cause degradation in image quality, especially for the layer 12 overlaid on the layer 11. To reduce data transmission, the processing unit 20 may also perform layer composition using a low-resolution buffer, which may further affect the display performance of the layer 12.

In addition, after the processing unit 20 performs the layer composition process, all layers (including the layer 12) will be composed into a complete composition layer and transmitted to the processing unit 10. Therefore, the processing unit 10 may only process the composed overall image (that is, the composition layer 13), and cannot perform targeted operations such as super-resolution and sharpening on the layer 12, which may have higher display requirements. In this case, the problem of image quality degradation or detail loss may occur for the key element or focal content corresponding to the layer 12, thus affecting the final display effect.

In view of this, an improved solution for display processing is proposed according to the embodiments of the present disclosure. The solution includes: receiving a composition layer to be presented on a display screen and auxiliary information of at least one first layer merged into the composition layer, the auxiliary information at least at least indicating a size of each first layer and a position of each first layer in the composition layer; performing, based on the auxiliary information of the at least one first layer, an image processing operation on at least one area in the composition layer to obtain a processed composition layer; and performing, based on the processed composition layer, presentation on the display screen.

In this way, while transmitting the composition layer to be presented on the display screen, the auxiliary information of each of the composed layers is retained. Based on the auxiliary information, before performing presentation of the composition layer on the display screen, a further image processing operation may be performed for different areas corresponding to each of the layers. In this way, the computing burden and rendering latency can be reduced by performing layer composition on a separate processing unit, and each specific area may be optimized separately to avoid image quality loss caused by layer composition and sampling. The image processing operation on the layer can compensate for problems such as loss of clarity or loss of details caused by resampling, and improve image quality. The display processing solution proposed by the embodiments of the present disclosure can achieve a balance between display performance and display effect.

Some example embodiments of the present disclosure will be described below with continued reference to the drawings. Furthermore, in the following, the example embodiments will be mainly described with respect to the terminal device 110.

FIG. 2 illustrates a flowchart of a process 200 of display processing according to some embodiments of the present disclosure. The process 200 may be implemented at the terminal device 110. The process 200 will be described below with reference to FIG. 1A.

At block 210, the terminal device 110 (or more specifically, a processing unit of the terminal device 110) receives a composition layer to be presented on a display screen and auxiliary information of at least one first layer merged into the composition layer. The auxiliary information at least indicates a size of each first layer and a position of each first layer in the composition layer.

The display screen refers to a device or area for displaying the display content of the terminal device 110. The display screen may be integrated into the terminal device 110 or be an external device connected to the terminal device 110. The display screen may include a physical display device or include a virtual projection display (for example, for the XR device).

The layer may also be understood as a display layer, and its function is to manage, in a layered manner, the presentation of a plurality of application interfaces or interface elements on the display screen. The layers mainly originate from the applications 120 in the terminal device 110, that is, the application interface of each application 120 may have one or more layers. The application interface is also referred to as an application window, or a window. In an environment where the plurality of application interfaces are presented on the display screen, the application interfaces of different applications 120 may occupy different display areas of the display screen, depending on the display positions and active states of the application interfaces.

In some embodiments, different application interfaces usually correspond to different layers. For example, a launcher application itself occupies one rendering layer. After a plurality of applications are launched (such as a video application, an office application, etc.), each application may create one or more layers respectively. If an application supports multi-interface display (for example, a browser application may open a plurality of tabs or sub-windows), each application interface may also correspond to a different layer.

In some embodiments, the layers may not be strictly divided by the applications, and the plurality of layers may also be divided within an application interface. For example, the background layer, the interaction layer (such as a handle, a UI control), the game character layer, etc. in the game application interface may respectively correspond to one layer. That is, an application interface may correspond to the plurality of layers. The specific number of the plurality of layers to be rendered on the display screen may depend on factors such as the number of launched applications, the interface complexity of the applications, and the specific display strategy.

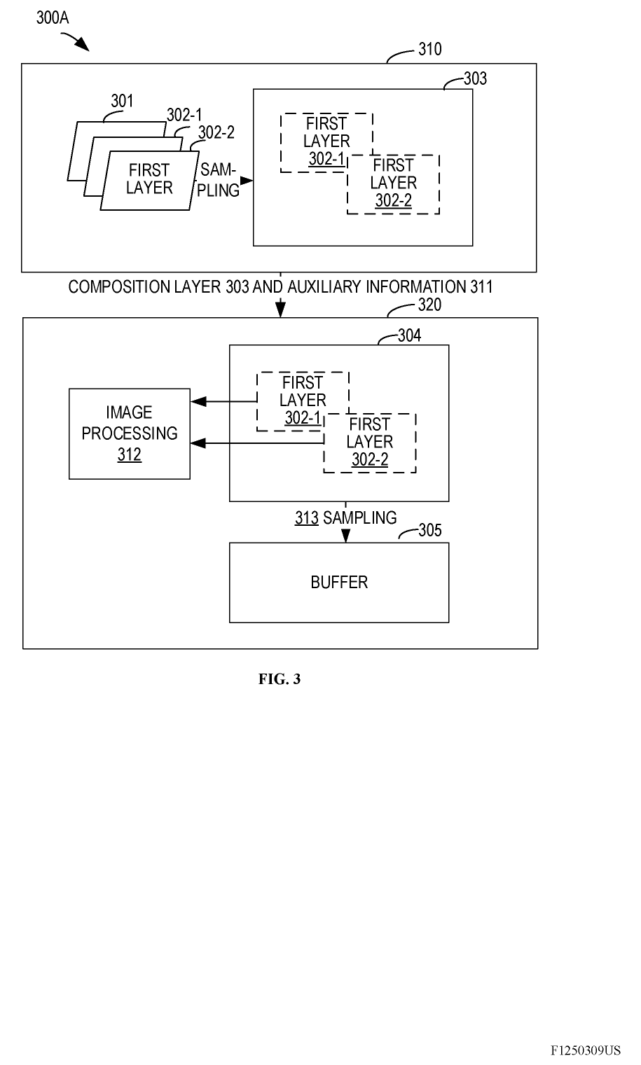

As an example, FIG. 3 illustrates a schematic diagram of an example display architecture 300A for display processing according to some embodiments of the present disclosure. The process 300A may be implemented at the terminal device 110.

Referring to FIG. 3, the terminal device 110 may include a first processing unit 310 and a second processing unit 320. The display processing method according to the embodiments of the present disclosure may be implemented in the second processing unit 320. The first processing unit 310 may be configured to perform a composition process of the plurality of layers and output a complete composition layer. The second processing unit 320 may be configured to perform subsequent image optimization and display adaptation, and deliver the final image data to the underlying hardware (such as a display screen) of the terminal device 110 to perform display on the screen. Through this architecture, the process of layer composition and subsequent display processing can be allocated to different execution units or modules, thereby reducing the computing burden, reducing the display latency, and improving the display effect.

In some embodiments, the first processing unit 310 is responsible for receiving, processing, and image data corresponding to the plurality of layers. The first processing unit 310 may perform layer composition on the received the plurality of layers, the plurality of layers including, for example, at least one layer 301 and at least one first layer 302 (for example, a first layer 302-1 and a first layer 302-2). For example, in a virtual reality and augmented reality platform, the first processing unit 310 that performs the layer composition process may be a spatial engine component for processing space-related data and logic. By composing the plurality of layers, it is ensured that the display content and visual elements corresponding to all layers are correctly superimposed on the composition layer 303. It should be understood that the above first layer 302-1 and first layer 302-2 are merely illustrative descriptions of the first layer 302 that may be included in the display processing process of the terminal device 110, and are not intended to limit the number and display sequence of the first layer 302 in the present disclosure in any form.

In some embodiments, the first layer 302 merged into the composition layer 303 includes an overlay layer. The overlay layer is a special type of composition layer used to present a texture on the layer 301 of the buffer (for example, the eyebuffer). For example, the first layer 302 may be a layer transmitted to the processing unit 310 through a passthrough mechanism, and is used to display information, text, video or other textures that need to be always located in front of the scene. Through the passthrough, the first layer 302 may be directly transmitted to the processing unit 310 and overlaid on the layer 301. Therefore, the first layer 302 is also referred to as a passthrough layer.

The eyebuffer refers to a buffer used to store the rendering result corresponding to respective eyes during the rendering process of the XR device. The content rendered to the eyebuffer will undergo subsequent processing (such as distortion correction, sampling, etc.) and finally be presented on the display screen.

The composition layer 303 is a final image formed after performing composition processing on the plurality of layers including the layer 301 and the first layer 302, and it includes a result of superimposing a plurality of independent layers. For example, the composition layer 303 may be a complete image including a plurality of different types of layers such as a UI layer, a background layer, a foreground layer, and the like.

In some embodiments, as a downstream module of the first processing unit 310, the second processing unit 320 may be configured to receive the output of the first processing unit and perform the subsequent display processing operations. For example, the second processing unit 320 may be a software layer, that is, a runtime environment, configured to coordinate hardware resources and manage the lifecycle of applications. The second processing unit 320 may receive the composition layer 303 and the auxiliary information 311 of the at least one first layer 302 from the first processing unit 310.

In order to ensure that the composed layer may still perform a separate image processing operation on the first layer 302 with higher display requirements, the terminal device 110 adopts an auxiliary information delivery mechanism. The auxiliary information 311 refers to a group of data additionally transmitted when transmitting the composition layer 303. The auxiliary information 311 describes specific information of each first layer 302, so that the second processing unit 320 may determine the specific area corresponding to the first layer 302 in the composition layer 303, thereby being able to perform targeted image processing operations. Since the composition of each first layer 302 is performed by the first processing unit 310, the first processing unit 310 may know the relevant information of each first layer 302 in the composition image 303, and deliver the auxiliary information 311 while delivering the composition layer 303 to the second processing unit 320.

In some embodiments, the auxiliary information 311 at least indicates a size of each first layer 302 and a position of each first layer in the composition layer 303. For example, the auxiliary information 311 may indicate the width and height of the first layer 302 to ensure that the second processing unit 320 may determine the exact size of the first layer 302. Alternatively or additionally, the auxiliary information 311 may further indicate the relative coordinates of the first layer 302 in the composition layer 303 (for example, the coordinates of the upper left corner, the center coordinates, and/or the coordinates of the lower right corner), so that the second processing unit 320 determines the position of the first layer 302 in the composition layer 303.

Continuing to refer to FIG. 2, at block 220, the terminal device 110 (or more specifically, the processing unit of the terminal device 110) performs, based on the auxiliary information of the at least one first layer, an image processing operation on at least one area in the composition layer to obtain a processed composition layer.

In some embodiments, the auxiliary information 311 provides description information about the size and the position of the first layer, and such information enables the terminal device 110 to accurately identify and locate the area where each first layer is located after receiving the composition layer, thereby performing targeted image processing operations.

Referring back to FIG. 3, in some embodiments, the auxiliary information 311 may further indicate a level of each first layer 302 in the composition layer 303. The level refers to a hierarchical relationship of the first layer 302 in the composition layer 303, which may be used to distinguish the priority or stacking order of different first layers 302. The hierarchical relationship is related to the display level of the display content corresponding to the first layer on the final display screen.

In some embodiments, the second unit 320 may determine an occlusion relationship between each first layer 302 based on the level of each of the at least one first layer 302 in the composition layer 303. For example, if the auxiliary information 311 indicates that the level of the first layer 302-2 is higher than that of the first layer 302-1, the area corresponding to the first layer 302-2 in the composition layer 303 may occlude a part or all of the area corresponding to the first layer 302-1 in the composition layer 303.

In some embodiments, for each first layer 302 of the at least one first layer 302, the second unit 320 may determine, based on the size of the first layer 302, the position of the first layer 302 in the composition layer, and the occlusion relationship of the first layer, an area corresponding to the first layer 302 and not occluded by other layers in the composition layer 303.

As an example, the second unit 320 may calculate the specific position of the layer on the composition layer 303 according to the size and position (such as width and height, and the coordinates of the upper left corner) of each first layer 302, thereby determining the display area corresponding to each first layer 302 in the composition layer 303. Then, the second unit 320 may determine whether the layer is partially or completely occluded by other layers based on the occlusion relationship. The second unit 320 may only perform image processing operations such as image quality enhancement or optimization on the unoccluded part of the area, that is, the area that may be seen or perceived by the user. For the occluded area that the user cannot perceive, the second unit 320 may not perform processing. In this way, unnecessary computing overhead can be avoided, thereby achieving a better balance between the display performance and display effect of each layer.

In some embodiments, the second unit 320 obtains the processed composition layer 304 by performing the image processing operation 312 on the at least one area in the composition layer 303. Through the auxiliary information 311, the second unit 320 may determine the effective area in the composition layer 303 that needs to undergo the image processing operation. Generally, the area in the composition layer that does not belong to the first layer (that is, the overlay layer) may not need to apply a further image processing area.

In some embodiments, the second unit 320 may determine whether the image processing operation needs to be performed according to the type and requirements of the effective area corresponding to each first layer 302 in the composition layer 303. For the area where the image processing operation needs to be performed, the second unit 320 may perform a targeted image processing operation 312 based on the corresponding image processing algorithm. This is because considering that the visual characteristics of the display content corresponding to different layers are different, there are also certain differences in the processing means that may be used to improve the image quality. By performing targeted processing operations on different areas in the composition layer 303, the display image quality of the composition image 304 may be enhanced, and the final display effect on the display screen may be improved.

In some embodiments, the image processing operation 312 includes at least one of a super-resolution operation, a sharpening operation, a supersampling operation, and a denoising operation. The super-resolution (Super-Resolution, SR) operation refers to an operation of enhancing a low-resolution image to a higher resolution through artificial intelligence or a traditional interpolation algorithm, thereby improving the image clarity.

The sharpening operation refers to an operation of enhancing the contrast of the image edge to make the image clearer and reduce blurring, which may be applied to scenarios such as enhancing the object contour in a 3D rendering scene and making the texture more delicate.

The supersampling operation refers to an operation of reducing aliasing and image distortion and improving detail performance by rendering a higher-resolution image and scaling it to a target resolution, which may be applied to a scenario of improving the smoothness of the edge of a 3D object in a VR/AR scene.

The denoising operation refers to an operation of optimizing image quality by removing random noise or artifacts in an image, which may be applied to a scenario of reducing noise and optimizing dark details in a scene with dim light or high dynamic range.

In other embodiments, the image processing operation 312 may further include more, fewer or different appropriate processing operations that may improve the image quality.

In some embodiments, the auxiliary information 311 further indicates a type of the image processing operation corresponding to each of the at least one first layer 302. Based on the received auxiliary information 311, the second unit 320 may determine the type of the image processing operation 312 corresponding to the first layer 302, and perform, according to the indicated type of image processing, the image processing operation 312 on the area corresponding to the first layer 302 in the at least one area. In some embodiments, depending on the specific image condition of the first layer 302, some first layers may not need to perform further image processing, and therefore may not need to provide the type of image processing.

As an example, after composing each of the layers, the first processing unit 310 may further deliver the type of the image processing operation 312 corresponding to the first layer 302 to the second processing unit 320 in addition to sending the position, size, and level information of the first layer 302. After receiving this information, the second processing unit 320 may perform the corresponding image processing operation 312 on the area corresponding to the first layer 302 based on the predetermined operation type. Since the operation type has been determined, the second processing unit 320 may directly perform the corresponding image processing operation 312, thereby avoiding unnecessary analysis and calculation. In this way, the efficiency of image processing may be improved.

In some embodiments, the second processing unit 320 may further perform image analysis on the area corresponding to the first layer 302 to determine whether the area needs to perform the image processing operation and what type of image processing operation 312 is needed. In such an embodiment, the first processing unit 310 may not need to deliver to the second processing unit 320 the type of image processing operation required by each first layer.

In some embodiments, the second processing unit 320 may determine, based on a frequency domain feature of each of the at least one area in the composition layer 303 and/or a relative relationship between a resolution of the composition layer 303 and a resolution of the display screen, a type of the image processing operation 312 corresponding to each of the at least one area. Then the second processing unit 320 may perform, based on the type of the image processing operation 312 corresponding to each of the at least one area, a corresponding image processing operation 312 on the at least one area, respectively.

As an example, the second processing unit 320 may determine the type of the image processing operation 312 a frequency domain feature of each of the at least one area in the composition layer 303. The second processing unit 320 may first determine the area corresponding to each first layer 302 from the composition layer 303 based on the auxiliary information 311 (position, size, and level information) received from the first processing unit 310. Then, the second processing unit 320 may perform image quality analysis on these areas based on a frequency domain transform manner. For example, the second processing unit 320 may perform a Fourier transform on each area, thereby transforming the image data of the area into a frequency domain feature, and analyzing the frequency distribution characteristics of the area.

The second processing unit 320 may determine, based on the analysis result, the area in the composition layer 303 that needs to perform the image processing operation 312, and select an appropriate image processing strategy for different areas, thereby performing the corresponding image processing operation 312 on the corresponding area. For example, if the low-frequency component in a certain area is dominant (the frequency domain values of most pixels do not exceed a certain threshold), it indicates that the area is relatively blurred, and is suitable for performing a sharpening operation or a super-resolution operation to enhance details and make the image clearer. If there are many high-frequency components in a certain area (the frequency domain values of a large number of pixels exceed a certain proportion of the threshold), it indicates that the area is relatively sharp, and is suitable for performing a denoising or supersampling operation to reduce noise in the image and make the image smoother.

Alternatively or additionally, the second processing unit 320 may determine the type of the image processing operation 312 based on the relative relationship between the resolution of the composition layer 303 and the resolution of the display screen. If the resolution of the composition layer 303 is greater than the resolution of the display screen (for example, several times larger than the resolution of the display screen), the resolution of the composition layer 303 may need to be reduced in the subsequent operation to adapt to the display screen. In the process of reduction, some pixels may be skipped (sampling loss), resulting in uneven details and problems such as jagged flicker or moiré. Therefore, a supersampling operation may be performed on the composition layer to make the area corresponding to the first layer 302 smoother through multiple sampling and filtering, thereby preventing jagged edges caused by sampling. If the resolution of the composition layer 303 is less than the resolution of the display screen (for example, several times smaller than the resolution of the display screen), the composition layer 303 may need to be upscaled in the subsequent operation. During upscaling, an interpolation method may be used to fill the layer pixels, which leads to problems such as image blurring and unclear boundaries. In this case, the details of the boundary in the image may be highlighted and the image quality of the area corresponding to the first layer 302 may be improved by a super-resolution operation or sharpening.

In some examples, the second processing unit 320 may also consider both the frequency domain feature of each of at least one area in the composition layer 303 and the relative relationship between the resolution of the composition layer 303 and the resolution of the display screen to determine the type of the image processing operation 312. For example, it may be determined that the sharpening operation or the super-resolution operation needs to be performed on the composition layer when the frequency domain feature satisfies the conditions discussed above and the relative relationship between the resolutions also satisfies the corresponding conditions, otherwise it may be determined that the supersampling operation is to be performed.

It should be understood that the above are example embodiments for determining a type of the image processing operation for each area in the composition layer. In other embodiments, the type of the image processing operation for a specific area may also be analyzed and determined according to any other appropriate method.

As an example, in a display device such as a VR, a foveated rendering (Foveated Rendering) technology may be applied. This is a rendering technology that, based on the visual characteristics of human eyes, only renders a high-resolution image of the center of the field of view (gaze point), while the resolution of the remaining area is reduced, thereby saving computing resources and bandwidth. Although this may improve the display performance, if some areas of the first layer 302 are located in the low-resolution area, the image quality may be affected. In this case, the terminal device 110 may perform the aforementioned image processing operations on these areas to compensate for the decline in image quality and improve the display effect.

By analyzing the frequency domain characteristics of each area, the second processing unit 320 may adaptively select the image quality enhancement and image processing strategy most suitable for each different area. In this way, the degree of blurring or sharpening of the image may be more accurately determined, so that various targeted image optimization algorithms may be accurately applied. In this way, the flexibility and adaptability of image processing can be improved, ensuring an optimal visual experience across different devices and scenarios, and enabling smarter display processing.

Returning to FIG. 2, at block 230, the terminal device 110 performs, based on the processed composition layer, presentation on the display screen. After the image processing operation, each area (especially the area corresponding to the first layer) in the composition layer has been optimized accordingly. The terminal device 110 may send the final composition layer to the display system and perform presentation according to parameters such as the resolution, refresh rate, and color configuration of the display device.

In some examples, in order to save bandwidth and reduce data transmission volume, the first processing unit 310 may reduce the resolution of the composition layer and deliver the composition layer with a smaller resolution to the second processing unit 320. Therefore, as shown in FIG. 3, after receiving the composition layer 304, the second processing unit 320 may perform a sampling operation 313 on the processed composition layer 304 to enable the sampled composition layer to match the resolution of the display screen. Then, the composition layer sampled by the second processing unit 320 is sent to a buffer 305 of the display screen to perform presentation on the display screen.

The sampling operation 313 is a process of extracting image data and adjusting image resolution in display processing. For example, the second processing unit 320 may select required pixels from the composition layer according to the resolution of the display screen, and perform a downsampling operation or an upsampling operation to ensure that the sampled composition layer may adapt to display screens of different sizes.

In some embodiments, in addition to the sampling operation 313, the second processing unit 320 may further perform other operations on the composition layer 304 to improve the final display effect. For example, the color information of the composition layer is converted into a color format supported by the display screen through a color space conversion operation, the sampled composition layer is synchronized with the refresh rate of the display screen through a frame synchronization processing operation to avoid image tearing, or the image distortion caused by the display device or lens is eliminated through an anti-distortion operation.

After the sampling operation, the second processing unit 320 may store the composition layer after sampling processing into the buffer 305. The buffer 305 is an image buffer of the display screen, and its size and resolution usually match the resolution of the display screen (such as a mobile phone screen, a VR headset, etc.). The buffer 305 may include, for example, an eyebuffer. In the process of image rendering, the buffer plays the role of temporary storage and data transmission. For example, the buffer 305 may be a single buffer used to store the image data of the current frame. In some rendering architectures with higher performance requirements, the buffer 305 may also be double buffering or triple buffering to improve display performance and reduce latency.

After the buffer 305 stores the data of the sampled composition layer, this image data is delivered to the display hardware to perform presentation. For example, the image data is sent to a display controller through a hardware abstraction layer module responsible for window composition and display. The hardware abstraction layer module may act as an interface between the application and the hardware, so that the image data stored in the buffer 305 may be transmitted to the display controller. The display controller may convert the image data into a screen signal and send it to the display screen, and scan and display the corresponding frame data line by line according to the refresh rate of the display screen.

In summary, according to various embodiments of the present disclosure, by receiving the composition layer and the auxiliary data of the first layer, the second processing unit can accurately identify the area corresponding to the first layer in the composition layer, thereby performing targeted image processing operations. In this way, the computing burden of the second processing unit can be reduced, the efficiency of display processing can be improved, and at the same time, additional image quality loss can be avoided. In this way, a balance between display performance and display effect can be achieved, and the overall display experience can be improved.

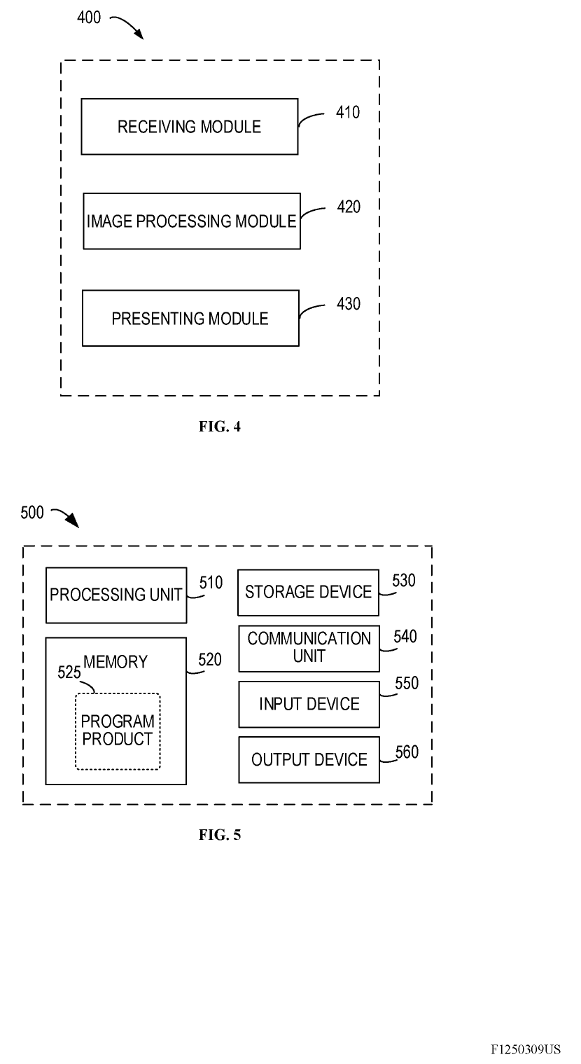

FIG. 4 illustrates a schematic structural block diagram of an apparatus 400 for display processing according to some embodiments of the present disclosure. The apparatus 400 may, for example, be implemented or included in the terminal device 110. Each module/component in the apparatus 400 may be implemented by hardware, software, firmware, or any combination thereof.

As shown in FIG. 4, the apparatus 400 includes a receiving module 410 configured to receive a composition layer to be presented on a display screen and auxiliary information of at least one first layer merged into the composition layer, the auxiliary information at least indicating a size of each first layer and a position of each first layer in the composition layer; an image processing module 420 configured to perform, based on the auxiliary information of the at least one first layer, an image processing operation on at least one area in the composition layer to obtain a processed composition layer; and a presenting module 430 configured to perform, based on the processed composition layer, presentation on the display screen.

In some embodiments, the image processing module 420 is further configured to determine, based on the auxiliary information of the at least one first layer, the at least one area in the composition layer on which the image processing operation is to be performed, each area corresponding to one layer of the at least the first layer; and obtain the processed composition layer by performing the image processing operation on the at least one area in the composition layer.

In some embodiments, the auxiliary information further indicates a level of each first layer in the composition layer. The image processing module 420 is further configured to determine an occlusion relationship between each first layer based on the level of each of the at least one first layer in the composition layer; and determine, for each first layer of the at least one first layer, an area corresponding to each first layer and not occluded by other layers in the composition layer based on the size, the position in the composition layer, and the occlusion relationship of the first layer.

In some embodiments, the auxiliary information further indicates a type of the image processing operation corresponding to each of the at least one first layer. The image processing module 420 is further configured to perform, for each first layer of the at least one first layer, the image processing operation on the area corresponding to the first layer in the at least one area based on the type of the image processing operation corresponding to the first layer.

In some embodiments, the image processing module 420 is further configured to determine a type of the image processing operation corresponding to each of the at least one area based on at least one of the following: a frequency domain feature of each of the at least one area in the composition layer, a relative relationship between a resolution of the composition layer and a resolution of the display screen; and perform, based on the type of the image processing operation corresponding to each of the at least one area, a corresponding image processing operation on the at least one area, respectively.

In some embodiments, the presenting module 430 is further configured to perform a sampling operation on the processed composition layer to match the sampled composition layer with the resolution of the display screen; and send the sampled composition layer to a buffer of the display screen to perform the presentation on the display screen.

In some embodiments, the apparatus 400 is implemented as a second processing unit, and the composition layer and the auxiliary information are received by the second processing unit from a first processing unit, the first processing unit being at least configured to perform layer merging.

In some embodiments, the image processing operation includes at least one of a super-resolution operation, a sharpening operation, a super-sampling operation, and a denoising operation.

The units and/or modules included in the apparatus 400 may be implemented in various ways, including software, hardware, firmware, or any combination thereof. In some embodiments, one or more units and/or modules may be implemented using software and/or firmware, such as machine-executable instructions stored on a storage medium. In addition to machine-executable instructions or as an alternative, some or all units and/or modules in the apparatus 400 may be implemented at least partially by one or more hardware logic components. As an example, rather than a limitation, example types of hardware logic components that may be used include field programmable gate array (FPGA), application specific integrated circuit (ASIC), application specific standard products (ASSP), system on chip (SOC), complex programmable logic device (CPLD), and so on.

It should be understood that one or more steps in the above method may be performed by an appropriate electronic device or combination of electronic devices. Such an electronic device or combination of electronic devices may include, for example, the terminal device 110 and/or the server 130 in FIG. 1A.

FIG. 5 illustrates a block diagram of an electronic device 500 in which one or more embodiments in the present disclosure may be implemented. It would be appreciated that the electronic device 500 illustrated in FIG. 5 is merely illustrative and should not constitute any limitation on the functionality and scope of the embodiments described herein. The electronic device 500 shown in FIG. 5 may include or be implemented as the terminal device 110 in FIG. 1 or the apparatus 400 in FIG. 4.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor capable of performing various processes according to a program stored in the memory 520. In a multiprocessor system, a plurality of processing units execute computer-executable instructions in parallel to improve the parallel processing capabilities of electronic device 500.

The electronic device 500 typically includes a variety of computer storage media. Such media may be any available media that are accessible to the electronic device 500, including, but not limited to, volatile and non-volatile media, removable and non-removable media. The memory 520 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, magnetic disk, or any other medium that can be used to store information and/or data and that can be accessed within the electronic device 500.

The electronic device 500 may further include an additional removable/non-removable, volatile/non-volatile storage medium. Although not shown in FIG. 5, a disk drive for reading from or writing to a removable, non-volatile magnetic disk (e.g., a “floppy disk”) or an optical disk drive for reading from or writing to a removable, non-volatile optical disk may be provided. In these cases, each drive may be connected to a bus (not shown) by one or more data media interfaces. The memory 520 may include a computer program product 525 having one or more program modules configured to execute various methods or actions of the various embodiments in the present disclosure.

The communication unit 540 is configured to communicate with other electronic devices through a communication medium. Additionally, the functionality of components of the electronic device 500 may be implemented by a single computing cluster or multiple computing machines capable of communicating through a communication connection. Thus, the electronic device 500 may operate in a networked environment using a logical connection with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed. The external device, such as a storage device, a display device, etc., communicates with one or more devices that enable users to interact with the electronic device 500, or communicates with any device (e.g., a network card, a modem, etc.) that enables the electronic device 500 to communicate with one or more other electronic devices. Such communication may be performed via an input/output (I/O) interface (not shown).

According to example implementations in the present disclosure, a computer-readable storage medium having computer-executable instructions stored thereon is provided. The computer-executable instructions are executed by a processor to implement the method described above. According to example implementations in the present disclosure, a computer program product is further provided. The computer program product is tangibly stored on a non-transitory computer-readable medium and includes computer-executable instructions. The computer-executable instructions are executed by a processor to implement the method described above.

Various aspects in the present disclosure are described herein with reference to flowcharts and/or block diagrams of methods, apparatuses, devices, and computer program products implemented according to the present disclosure. It would be appreciated that each block of the flowchart and/or block diagram, and combinations of blocks in the flowcharts and/or block diagrams, may be implemented by computer readable program instructions.

These computer-readable program instructions may be provided to a processing unit of a general-purpose computer, special computer, or other programmable data processing apparatus to produce a machine that generates an apparatus to implement the functions/acts specified in one or more blocks in the flowchart and/or the block diagram when these instructions are executed through the processing units of the computer or other programmable data processing devices. These computer-readable program instructions may also be stored in a computer-readable storage medium. These instructions cause the computer, programmable data processing apparatus, and/or other devices to work in a specific way. Therefore, the computer-readable medium storing instructions includes an article of manufacture including instructions to implement aspects of the functions/acts specified in one or more blocks in the flowchart and/or block diagram(s).

The computer-readable program instructions may be loaded onto a computer, a programmable data processing apparatus, or a further device, such that a series of operational steps can be performed on the computer, programmable data processing apparatus, or the further device to produce a computer-implemented process. As such, the instructions executed on the computer, programmable data processing apparatus, or the further device implement the functions/acts specified in the one or more blocks in the flowchart and/or block diagram(s).

The flowchart and block diagrams in the drawings show the possible architecture, functions and operations of the system, the method, and the computer program product implemented according to various implementations in the present disclosure. In this regard, each block in the flowchart or block diagram may represent a part of a module, a program segment or instructions, which contains one or more executable instructions for implementing the specified logic function(s). In some alternative implementations, the functions marked in the blocks may also occur in a different order from those marked in the drawings. For example, two consecutive blocks may be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by a combination of a dedicated hardware and computer instructions.

Various implementations in the present disclosure have been described above. The above description is illustrative, not exhaustive, and the present application is not limited to the disclosed implementations. Without departing from the scope and spirit of the described implementations, many modifications and changes are obvious to those skilled in the art. The terminology used herein has been chosen to best explain the principles of the respective implementations, the practical applications or improvements to the technology in the marketplace, or to enable those skilled in the art to understand the implementations disclosed herein.

I/We claim:

1. A display processing method, comprising:
receiving a composition layer to be presented on a display screen and auxiliary information of at least one first layer merged into the composition layer, the auxiliary information at least indicating a size of each first layer and a position of each first layer in the composition layer;
performing, based on the auxiliary information of the at least one first layer, an image processing operation on at least one area in the composition layer to obtain a processed composition layer; and
performing, based on the processed composition layer, presentation on the display screen.

2. The method of claim 1, wherein performing image processing operation on the composition layer to obtain the processed composition layer comprises:
determining, based on the auxiliary information of the at least one first layer, the at least one area in the composition layer on which the image processing operation is to be performed, each area corresponding to one layer of the at least the first layer; and
obtaining the processed composition layer by performing the image processing operation on the at least one area in the composition layer.

3. The method of claim 2, wherein the auxiliary information further indicates a level of each first layer in the composition layer, and wherein determining, based on the auxiliary information of the at least one first layer, the at least one area in the composition layer on which the image processing operation is to be performed comprises:
determining an occlusion relationship between each first layer based on the level of each of the at least one first layer in the composition layer; and
determining, for each first layer of the at least one first layer, an area corresponding to each first layer and not occluded by other layers in the composition layer based on the size, the position in the composition layer, and the occlusion relationship of the first layer.

4. The method of claim 1, wherein the auxiliary information further indicates a type of the image processing operation corresponding to each of the at least one first layer, and wherein performing the image processing operation on the at least one area in the composition layer comprises:
performing, for each first layer of the at least one first layer, the image processing operation on the area corresponding to the first layer in the at least one area based on the type of the image processing operation corresponding to the first layer.

5. The method of claim 1, wherein performing the image processing operation on the at least one area in the composition layer further comprises:
determining a type of the image processing operation corresponding to each of the at least one area based on at least one of the following:
a frequency domain feature of each of the at least one area in the composition layer,
a relative relationship between a resolution of the composition layer and a resolution of the display screen; and
performing, based on the type of the image processing operation corresponding to each of the at least one area, a corresponding image processing operation on the at least one area, respectively.

6. The method of claim 1, wherein performing presentation on the display screen based on the processed composition layer comprises:
performing a sampling operation on the processed composition layer to match the sampled composition layer with the resolution of the display screen; and
sending the sampled composition layer to a buffer of the display screen to perform the presentation on the display screen.

7. The method of claim 1, wherein the method is implemented in a second processing unit, and the composition layer and the auxiliary information are received by the second processing unit from a first processing unit, the first processing unit being at least configured to perform layer merging.

8. The method of claim 1, wherein the image processing operation comprises at least one of a super-resolution operation, a sharpening operation, a super-sampling operation, and a denoising operation.

9. An electronic device, comprising:
at least one processor; and
at least one memory coupled to the at least one processor and storing instructions for execution by the at least one processor, the instructions, when executed by the at least one processor, causing the electronic device to perform acts comprising:
receiving a composition layer to be presented on a display screen and auxiliary information of at least one first layer merged into the composition layer, the auxiliary information at least indicating a size of each first layer and a position of each first layer in the composition layer;
performing, based on the auxiliary information of the at least one first layer, an image processing operation on at least one area in the composition layer to obtain a processed composition layer; and
performing, based on the processed composition layer, presentation on the display screen.

10. The electronic device of claim 9, wherein performing image processing operation on the composition layer to obtain the processed composition layer comprises:
determining, based on the auxiliary information of the at least one first layer, the at least one area in the composition layer on which the image processing operation is to be performed, each area corresponding to one layer of the at least the first layer; and
obtaining the processed composition layer by performing the image processing operation on the at least one area in the composition layer.

11. The electronic device of claim 10, wherein the auxiliary information further indicates a level of each first layer in the composition layer, and wherein determining, based on the auxiliary information of the at least one first layer, the at least one area in the composition layer on which the image processing operation is to be performed comprises:
determining an occlusion relationship between each first layer based on the level of each of the at least one first layer in the composition layer; and
determining, for each first layer of the at least one first layer, an area corresponding to each first layer and not occluded by other layers in the composition layer based on the size, the position in the composition layer, and the occlusion relationship of the first layer.

12. The electronic device of claim 9, wherein the auxiliary information further indicates a type of the image processing operation corresponding to each of the at least one first layer, and wherein performing the image processing operation on the at least one area in the composition layer comprises:
performing, for each first layer of the at least one first layer, the image processing operation on the area corresponding to the first layer in the at least one area based on the type of the image processing operation corresponding to the first layer.

13. The electronic device of claim 9, wherein performing the image processing operation on the at least one area in the composition layer further comprises:
determining a type of the image processing operation corresponding to each of the at least one area based on at least one of the following:
a frequency domain feature of each of the at least one area in the composition layer,
a relative relationship between a resolution of the composition layer and a resolution of the display screen; and
performing, based on the type of the image processing operation corresponding to each of the at least one area, a corresponding image processing operation on the at least one area, respectively.

14. The electronic device of claim 9, wherein performing presentation on the display screen based on the processed composition layer comprises:
performing a sampling operation on the processed composition layer to match the sampled composition layer with the resolution of the display screen; and
sending the sampled composition layer to a buffer of the display screen to perform the presentation on the display screen.

15. The electronic device of claim 9, wherein the acts is implemented in a second processing unit, and the composition layer and the auxiliary information are received by the second processing unit from a first processing unit, the first processing unit being at least configured to perform layer merging.

16. The electronic device of claim 9, wherein the image processing operation comprises at least one of a super-resolution operation, a sharpening operation, a super-sampling operation, and a denoising operation.

17. A non-transitory computer-readable storage medium having computer-executable instructions stored thereon, the computer-executable instructions being executable by a processor to implement acts comprising:
receiving a composition layer to be presented on a display screen and auxiliary information of at least one first layer merged into the composition layer, the auxiliary information at least indicating a size of each first layer and a position of each first layer in the composition layer;
performing, based on the auxiliary information of the at least one first layer, an image processing operation on at least one area in the composition layer to obtain a processed composition layer; and
performing, based on the processed composition layer, presentation on the display screen.

18. The non-transitory computer-readable storage of claim 17, wherein performing image processing operation on the composition layer to obtain the processed composition layer comprises:
determining, based on the auxiliary information of the at least one first layer, the at least one area in the composition layer on which the image processing operation is to be performed, each area corresponding to one layer of the at least the first layer; and
obtaining the processed composition layer by performing the image processing operation on the at least one area in the composition layer.

19. The non-transitory computer-readable storage of claim 18, wherein the auxiliary information further indicates a level of each first layer in the composition layer, and wherein determining, based on the auxiliary information of the at least one first layer, the at least one area in the composition layer on which the image processing operation is to be performed comprises:
determining an occlusion relationship between each first layer based on the level of each of the at least one first layer in the composition layer; and
determining, for each first layer of the at least one first layer, an area corresponding to each first layer and not occluded by other layers in the composition layer based on the size, the position in the composition layer, and the occlusion relationship of the first layer.

20. The non-transitory computer-readable storage of claim 17, wherein the auxiliary information further indicates a type of the image processing operation corresponding to each of the at least one first layer, and wherein performing the image processing operation on the at least one area in the composition layer comprises:
performing, for each first layer of the at least one first layer, the image processing operation on the area corresponding to the first layer in the at least one area based on the type of the image processing operation corresponding to the first layer.
